(19) United States
(12) Patent Application Publication
(10) Pub. No.: US 2015/0331558 A1
(43) Pub. Date: Nov. 19, 2015

(54) METHOD FOR SWITCHING PICTURES OF PICTURE GALLERIES AND BROWSER

(71) Applicant: TENCENT TECHNOLOGY (SHENZHEN) COMPANY LIMITED, Guangdong (CN)

(72) Inventors: Shuo DENG, Shenzhen (CN); Chuanchuan BO, Shenzhen (CN); Chundong HU, Shenzhen (CN); Liang ZENG, Shenzhen (CN); Tianyang LIU, Shenzhen (CN)

(21) Appl. No.: 14/648,246

(22) PCT Filed: Nov. 21, 2013
(86) PCT No.: PCT/CN2013/087548

§ 371 Date: May 28, 2015

(30) Foreign Application Priority Data
Nov. 29, 2012 (CN) 201210499259.6

(51) Int. Cl. G06F 3/0482; H04L 29/08; G06F 3/0484

(52) U.S. Cl. CPC G06F 3/0482; G06F 3/04845; G06F 3/04842; H04L 67/02

(57) ABSTRACT

A method for switching pictures of picture galleries and a browser are described. After receiving a picture switching instruction, judging whether an original picture gallery corresponding to an original picture displayed on a picture gallery interface and a target picture gallery corresponding to a target picture are a same gallery. If the original picture gallery and the target picture gallery are different, generating a picture gallery-picture gradual change switch mode. According to the picture gallery-picture gradual change switch mode, switching the original picture displayed on the picture gallery interface to the target picture.

This application claims the benefit of priority from Chinese Patent Application, No. 201210499259.6, filed on Nov. 29, 2012, the entire contents of which are hereby incorporated by reference.

### FIELD OF THE DISCLOSURE

The present disclosure relates to mobile communication technology, and more particularly to a method for switching pictures of picture galleries and a browser.

### BACKGROUND

With the rapid development of the mobile communication technology, the number of users who use mobile terminals is more and more, and the mobile terminals can realize more and more functions. Each mobile terminal can store a variety of pictures of different categories, and can store the pictures of different categories in different picture galleries according to categories. When a user wants to browse pictures, a mobile terminal browser can switch pictures of different picture galleries for displaying.

At present, the browser usually uses a direct switching mode to switch pictures of different picture galleries for displaying and also uses the direct switching mode to switch pictures of a same picture gallery for displaying, which results in low switch accuracy. Further, when switching pictures of different picture galleries for displaying, since titles and contents of pictures from different picture galleries are entirely different, for example, titles and contents of a landscape picture gallery and a war picture gallery are entirely different, if using the direct switching mode, i.e., directly switching a picture displayed on a picture gallery interface from a picture of the landscape picture gallery to a picture of the war picture gallery, it will result in that titles and contents of pictures displayed by the browser before and after the switching are entirely different, thereby affecting the effect of that the browser switches the pictures of different picture galleries for displaying.

### SUMMARY

One example of the present disclosure provides a method for switching pictures of picture galleries and a browser, which can improve switch accuracy of the browser when the browser performs switching pictures of picture galleries and can realize gradually-changed switching pictures of different picture galleries.

The technical solution adopted in one example of the present disclosure can be as follows.

A method for switching pictures of picture galleries includes:
after receiving a picture switching instruction, judging whether an original picture gallery corresponding to an original picture that is displayed on a picture gallery interface and a target picture gallery corresponding to a target picture are a same gallery, wherein the target picture is a picture to be switched corresponding to the original picture;
if the original picture gallery and the target picture gallery are different, generating a picture gallery-picture gradual change switch mode; wherein the picture gallery-picture gradual change switch mode is configured to gradually-changed switch the original picture to the target picture;
according to the picture gallery-picture gradual change switch mode, switching the original picture displayed on the picture gallery interface to the target picture.

A browser device includes:
a receiving unit configured to receive a picture switching instruction;
a judgment unit configured to, after the receiving unit receives the picture switching instruction, judge whether an original picture gallery corresponding to an original picture displayed on a picture gallery interface and a target picture gallery corresponding to a target picture are a same gallery; wherein the target picture is a picture to be switched corresponding to the original picture;
a first generation unit configured to, if the judgment unit judges that the original picture gallery and the target picture gallery are different, generate a picture gallery-picture gradual change switch mode; wherein the picture gallery-picture gradual change switch mode is configured to gradually-changed switch the original picture to the target picture;
a switching unit configured to, according to the picture gallery-picture gradual change switch mode generated by the first generation unit, switch the original picture displayed on the picture gallery interface to the target picture.

A non-transitory computer-readable storage medium comprising a set of instructions for performing a method for switching pictures of picture galleries, the set of instructions to direct at least one processor to perform acts of:
receiving a picture switching instruction and judging whether an original picture gallery corresponding to an original picture displayed on a picture gallery interface and a target picture gallery corresponding to a target picture are a same gallery, wherein the target picture is a picture to be switched corresponding to the original picture;
if the original picture gallery and the target picture gallery are same, directly switching the original picture to the target picture;
if the original picture gallery and the target picture gallery are different, indirectly switching the original picture to the target picture.

Comparing with that the browser in the related art uses the direct switching mode to switch pictures of different picture galleries for displaying and also uses the direct switching mode to switch pictures of a same picture gallery for displaying, the method for switching pictures of picture galleries and the browser provided in one example of the present disclosure can first judge whether the current picture switching is to switch pictures of different picture galleries so as to improve accuracy of switching pictures of picture galleries, and can gradually-changed switch the pictures of different picture galleries according to the picture gallery-picture gradual change switch mode, thereby improving the effect of that the browser switches the pictures of different picture galleries for displaying.

### BRIEF DESCRIPTION OF DRAWINGS

FIG. 1 is a flow chart of a method for switching pictures of picture galleries according to one example of the present disclosure;

FIG. 2 is a flow chart of another method for switching pictures of picture galleries according to one example of the present disclosure;

FIG. 3 is a schematic diagram of a browser according to one example of the present disclosure;

FIG. 4 is a schematic diagram of another browser according to one example of the present disclosure;

FIG. 5 is a schematic diagram of a browser device according to one example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

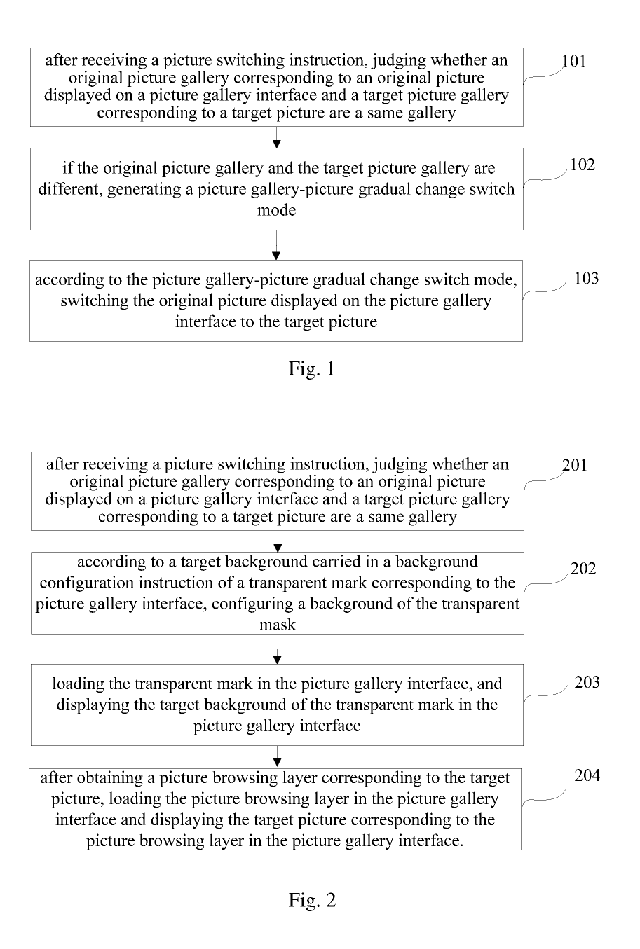

One example of the present disclosure provides a method for switching pictures of picture galleries, as shown in FIG. 1, the method includes:

101: after receiving a picture switching instruction, judging whether an original picture gallery corresponding to an original picture displayed on a picture gallery interface and a target picture gallery corresponding to a target picture are a same gallery.

The target picture is a picture to be switched corresponding to the original picture. Specifically, the original picture can be a last picture of the original picture gallery and the target picture can be a first picture of the target picture gallery; that is, at this moment, the user has finished browsing pictures of the original picture gallery, and will browse a picture of the next picture gallery. The original picture can also be any one picture of the original picture gallery and the target picture can be any one picture of the target picture gallery; that is, when the user browses pictures of the original picture gallery, because the pictures of the original picture gallery cannot meet the user's demand, thus, the user wants to jump to other picture gallery for browsing. It should be noted, the above application scenarios are only examples for illustration, not used to limit examples of the present disclosure.

102: if the original picture gallery and the target picture gallery are different, generating a picture gallery-picture gradual change switch mode.

The picture gallery-picture gradual change switch mode is configured to gradually-changed switch the original picture to the target picture.

103: according to the picture gallery-picture gradual change switch mode, switching the original picture displayed on the picture gallery interface to the target picture.

Comparing with that the browser in the related art uses the direct switching mode to switch pictures of different picture galleries for displaying and also uses the direct switching mode to switch pictures of a same picture gallery for displaying, the method for switching pictures of picture galleries provided in one example of the present disclosure can first judge whether the current picture switching is to switch pictures of different picture galleries so as to improve accuracy of switching pictures of picture galleries, and can gradually-changed switch the pictures of different picture galleries according to the picture gallery-picture gradual change switch mode, thereby improving the effect of that the browser switches the pictures of different picture galleries for displaying.

Further, one example of the present disclosure provides another method for switching pictures of picture galleries, as shown in FIG. 2, the method includes following steps:

201: after receiving a picture switching instruction, judging whether an original picture gallery corresponding to an original picture displayed on a picture gallery interface and a target picture gallery corresponding to a target picture are a same gallery.

The target picture is a picture to be switched corresponding to the original picture. Specifically, the original picture can be a last picture of the original picture gallery and the target picture can be a first picture of the target picture gallery; that is, the user has finished browsing pictures of the original picture gallery, and will browse a picture of the next picture gallery. The original picture can also be any one picture of the original picture gallery and the target picture can be any one picture of the target picture gallery; that is, when the user browses pictures of the original picture gallery, because the pictures of the original picture gallery cannot meet the user's demand, thus, the user wants to jump to other picture gallery for browsing. It should be noted, the above application scenarios are only examples for illustration, not used to limit examples of the present disclosure.

202: according to a target background carried in a background configuration instruction of a transparent mark corresponding to the picture gallery interface, configuring a background of the transparent mask.

The target background of the transparent mark specifically can be a single color background such as a black background, a red background and so on, and can also be an image background, such as a landscape picture, a character picture and son on. This is not specifically limited in this example of the present disclosure.

Before the step 202, this method can further include: generating a reminder prompt message of switching pictures of picture galleries, and outputting the reminder prompt message of switching pictures of picture galleries on the picture gallery interface. The reminder prompt message of switching pictures of picture galleries includes one of following messages: an audio message, a video message, a terminal vibration message and a text message, or any combination thereof.

Specifically, for example, the browser can play in the picture gallery interface an audio message that switching pictures will be carried out. Or, the browser can use a terminal vibration to remind a user of a prompt message that switching pictures will be carried out. Or, the browser can use a text box displayed in the picture gallery interface to prompt the user. Or, the browser can play in the picture gallery interface an animation video that switching pictures will be carried out so as to prompt the user. It should be noted, the above application scenarios are only examples for illustration, not used to limit examples of the present disclosure.

In addition, beside the above described means, the method can further adopt following means or solutions: generating an interactive prompt message of whether performing switching pictures of picture galleries, and outputting the interactive prompt message of whether performing switching pictures on the picture gallery interface. The interactive prompt message can be configured to confirm whether performing switching pictures of picture galleries. The interactive prompt message includes one of following messages: an audio message, a video message and a text message, or any combination thereof.

Specifically, for example, the browser can play in the picture gallery interface an audio prompt message of whether performing switching pictures. Or, the browser can display a text box prompt message of whether performing switching pictures in the picture gallery interface. Or, the browser can play in the picture gallery interface an animation video of whether performing switching pictures so as to prompt the user for confirmation. After the browser receives a confirmation of performing switching pictures, the browser generates a picture gallery-picture gradual change switch mode. It should be noted, the above application scenarios are only examples for illustration, not used to limit examples of the present disclosure.

203: loading the transparent mark in the picture gallery interface, and displaying the target background of the transparent mark in the picture gallery interface.

204: after obtaining a picture browsing layer corresponding to the target picture, loading the picture browsing layer in the picture gallery interface and displaying the target picture corresponding to the picture browsing layer in the picture gallery interface.

For one example of the present disclosure, the application scenarios can include, but not limited to, the following application scenarios. After receiving a picture switching instruction, if the browser judges that an original picture displayed on the picture gallery interface belongs to a war picture gallery and a picture to be switched corresponding to the original picture belongs to a landscape picture gallery, at this moment, the browser configures a background of a transparent mask which is to be loaded in the picture gallery interface to be black according to a background configuration instruction and then loads the transparent mask in the picture gallery interface. The browser sets transparency of the transparent mark to be 1 so that a screen displayed on the picture gallery interface is black. Setting transparency of the transparent mark to be 1 can make the layer non-transparent, and setting transparency of the transparent mark to be 0 can make the layer completely transparent. Then the browser loads a picture browsing layer of the picture to be switched, and displays the picture of the landscape picture gallery to be switched on the picture gallery interface through setting transparency of the picture browsing layer to be 1 and setting transparency of the transparent mark to be 0, so as to give the user an artistic conception that the day is darker and darker, and then a beautiful landscape picture appears in eyes during the process of switching pictures of different picture galleries. Therefore, the effect of that the browser switches the pictures of different picture galleries for displaying can be improved.

It should be noted, the above application scenarios are only examples for illustration, not used to limit examples of the present disclosure.

Comparing with that the browser in the related art uses the direct switching mode to switch pictures of different picture galleries for displaying and also uses the direct switching mode to switch pictures of a same picture gallery for displaying, the method for switching pictures of picture galleries provided in one example of the present disclosure can first judge whether the current picture switching is to switch pictures of different picture galleries so as to improve accuracy of switching pictures of picture galleries, and can gradually-changed switch the pictures of different picture galleries according to the picture gallery-picture gradual change switch mode, thereby improving the effect of that the browser switches the pictures of different picture galleries for displaying.

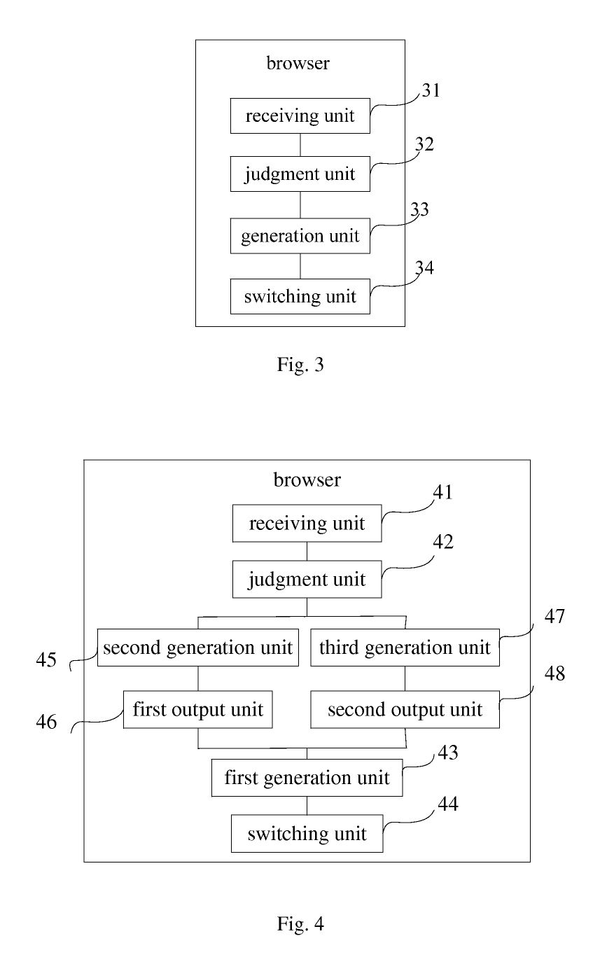

Further, one example of the present disclosure also provides a browser which can implement the method shown in FIG. 2. Here, the browser refers to a device including a program that accesses and displays files and other data available on the Internet and other network, and can also be called browser device. As shown in FIG. 3, the browser can include a receiving unit 31, a judgment unit 32, a generation unit 33 and a switching unit 34.

The receiving unit 31 is configured to receive a picture switching instruction.

The judgment unit 32 is configured to, after the receiving unit 31 receives the picture switching instruction, judge whether an original picture gallery corresponding to an original picture displayed on a picture gallery interface and a target picture gallery corresponding to a target picture are a same gallery. The target picture is a picture to be switched corresponding to the original picture.

The generation unit 33 can be configured to, if the judgment unit 32 judges that the original picture gallery and the target picture gallery are different, generate a picture gallery-picture gradual change switch mode. The picture gallery-picture gradual change switch mode is configured to gradually-changed switch the original picture to the target picture.

The switching unit 34 can be configured to switch the original picture displayed on the picture gallery interface to the target picture according to the picture gallery-picture gradual change switch mode generated by the generation unit 33.

Furthermore, one example of the present disclosure also provides another browser which can implement the method shown in FIG. 2. As shown in FIG. 4, the browser can include a receiving unit 41, a judgment unit 42, a first generation unit 43, a switching unit 44, a second generation unit 45, a first output unit 46, a third generation unit 47 and a second output unit 48.

The receiving unit 41 is configured to receive a picture switching instruction.

The judgment unit 42 is configured to, after the receiving unit 41 receives the picture switching instruction, judge whether an original picture gallery corresponding to an original picture displayed on a picture gallery interface and a target picture gallery corresponding to a target picture are a same gallery. The target picture is a picture to be switched corresponding to the original picture.

The first generation unit 43 can be configured to, if the judgment unit 42 judges that the original picture gallery and the target picture gallery are different, generate a picture gallery-picture gradual change switch mode. The picture gallery-picture gradual change switch mode is configured to gradually-changed switch the original picture to the target picture.

The switching unit 44 can be configured to, according to the picture gallery-picture gradual change switch mode generated by the first generation unit 43, switch the original picture displayed on the picture gallery interface to the target picture.

The first generation unit 43 can be configured to, according to a target background carried in a background configuration instruction of a transparent mark corresponding to the picture gallery interface, configure a background of the transparent mask.

The switching unit 44 can include:
a load display module 4401 configured to load the transparent mark in the picture gallery interface and display the target background of the transparent mark in the picture gallery interface;
an obtaining module 4402 configured to obtain a picture browsing layer corresponding to the target picture.

The load display module 4401 can further be configured to load the picture browsing layer obtained by the obtaining module 4402 in the picture gallery interface and display the target picture corresponding to the picture browsing layer in the picture gallery interface.

The second generation unit 45 can be configured to generate a reminder prompt message of switching pictures of picture galleries.

The first output unit 46 can be configured to output the reminder prompt message of switching pictures of picture galleries generated by the second generation unit 45.

The third generation unit 47 can be configured to generate an interactive prompt message of whether performing switching pictures of picture galleries.

The second output unit 48 can be configured to output the interactive prompt message of whether performing switching pictures generated by the third generation unit 47 on the picture gallery interface. The interactive prompt message can be configured to confirm whether performing switching pictures of picture galleries.

The first generation unit 43 can further be configured to, after receiving a confirmation of performing switching pictures of picture galleries corresponding to the interactive prompt message output by the second output unit 48, generate a picture gallery-picture gradual change switch mode.

It should be noted, other corresponding descriptions of each function unit related to the browser provided in one example of the present disclosure can refer to descriptions corresponding to FIG. 1 and FIG. 2, and will not be repeated here.

Comparing with that the browser in the related art uses the direct switching mode to switch pictures of different picture galleries for displaying and also uses the direct switching mode to switch pictures of a same picture gallery for displaying, the browser provided in one example of the present disclosure can first judge whether the current picture switching is to switch pictures of different picture galleries so as to improve accuracy of switching pictures of picture galleries, and can gradually-changed switch the pictures of different picture galleries according to the picture gallery-picture gradual change switch mode, thereby improving the effect of that the browser switches the pictures of different picture galleries for displaying.

The browser provided in this example of the present disclosure can implement the method provided in the above example, realization of specific functions can be referred to descriptions in the example of the method and will not be repeated here. The method for switching pictures of picture galleries and the browser provided in examples of the present disclosure can be applied in the mobile communication technology but is not limited to this.

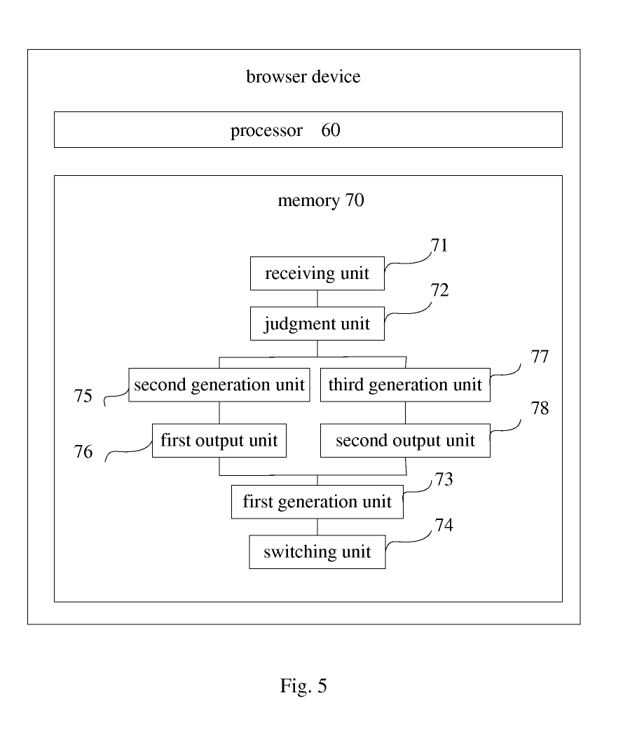

FIG. 5 shows a browser device according to one example of the present disclosure. As shown in FIG. 5, the browser device includes a processor 60 and a memory 70. The processor 60 and the memory 70 are connected with each other via an internal bus. The memory 70 may be a non-transitory computer-readable storage medium, and stores units of machine readable instructions executable by the processor 60, including a receiving unit 71, a judgment unit 72, a first generation unit 73, a switching unit 74, a second generation unit 75, a first output unit 46, a third generation unit 77 and a second output unit 78. Functions of the receiving unit 71, the judgment unit 72, the first generation unit 73, the switching unit 74, the second generation unit 75, the first output unit 76, the third generation unit 77 and the second output unit 78 are similar with the functions of the receiving unit 41, the judgment unit 42, the first generation unit 43, the switching unit 44, the second generation unit 45, the first output unit 46, the third generation unit 77 and the second output unit 78. The functions may be implemented with the assistance of other modules, and may involve cooperation of multiple modules, e.g., may utilize processing functions of the processor 60, may relay on the internal bus for data transmission, and etc.

The methods, units, modules, and browser described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided to store instructions to cause a machine to execute a process as described according to examples herein. Specifically, a system or apparatus having a storage medium that stores machine-readable program codes for implementing functions of any of the above examples and that may cause the system or the apparatus (or processor such as CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. The program code may be downloaded from a server computer via a communication network.

It should be noted that, alternatively to the program codes being executed by a computer, at least part of the operations performed by the program codes may be implemented by an operation system running in a computer following instructions based on the program codes to implement any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to implement any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

1. A method for switching pictures of picture galleries comprising:
after receiving a picture switching instruction, judging whether an original picture gallery corresponding to an original picture that is displayed on a picture gallery interface and a target picture gallery corresponding to a target picture are a same gallery, wherein the target picture is a picture to be switched corresponding to the original picture;
if the original picture gallery and the target picture gallery are different, generating a picture gallery-picture gradual change switch mode; wherein the picture gallery-picture gradual change switch mode is configured to gradually-changed switch the original picture to the target picture;
according to the picture gallery-picture gradual change switch mode, switching the original picture displayed on the picture gallery interface to the target picture;
wherein if the original picture gallery and the target picture gallery are different, generating a picture gallery-picture gradual change switch mode comprises:
configuring a background of a transparent mask corresponding to the picture gallery interface according to a target background carried in a background configuration instruction of the transparent mark corresponding to the picture gallery interface;
according to the picture gallery-picture gradual change switch mode, switching the original picture displayed on the picture gallery interface to the target picture comprises:
loading the transparent mark in the picture gallery interface, and displaying the target background of the transparent mark in the picture gallery interface;
after obtaining a picture browsing layer corresponding to the target picture, loading the picture browsing layer in the picture gallery interface and displaying the target picture corresponding to the picture browsing layer in the picture gallery interface.

2. (canceled)

3. The method of claim 1, wherein after judging that the original picture gallery and the target picture gallery are different, the method further comprises:
generating a reminder prompt message of switching pictures of picture galleries;
outputting the reminder prompt message of switching pictures of picture galleries on the picture gallery interface.

4. The method of claim 3, wherein the reminder prompt message of switching pictures of picture galleries comprises at least one of following messages: an audio message, a video message, a terminal vibration message and a text message.

5. The method of claim 1, wherein after judging that the original picture gallery and the target picture gallery are different, the method further comprises:
generating an interactive prompt message of whether performing switching pictures of picture galleries;
outputting the interactive prompt message of whether performing switching pictures on the picture gallery interface; wherein the interactive prompt message is configured to confirm whether performing switching pictures of picture galleries;
the generating a picture gallery-picture gradual change switch mode comprises: after receiving a confirmation of performing switching pictures of picture galleries, generating the picture gallery-picture gradual change switch mode.

6. The method of claim 5, wherein the interactive prompt message comprises at least one of following messages: an audio message, a video message and a text message.

7. A browser device, comprising:
a receiving unit configured to receive a picture switching instruction;
a judgment unit configured to, after the receiving unit receives the picture switching instruction, judge whether an original picture gallery corresponding to an original picture displayed on a picture gallery interface and a target picture gallery corresponding to a target picture are a same gallery; wherein the target picture is a picture to be switched corresponding to the original picture;
a first generation unit configured to, if the judgment unit judges that the original picture gallery and the target picture gallery are different, generate a picture gallery-picture gradual change switch mode; wherein the picture gallery-picture gradual change switch mode is configured to gradually-changed switch the original picture to the target picture;
a switching unit configured to, according to the picture gallery-picture gradual change switch mode generated by the first generation unit, switch the original picture displayed on the picture gallery interface to the target picture;
wherein
the first generation unit is configured to, according to a target background carried in a background configuration instruction of a transparent mark corresponding to the picture gallery interface, configure a background of the transparent mask;
the switching unit includes:
a load display module configured to load the transparent mark in the picture gallery interface and display the target background of the transparent mark in the picture gallery interface;
an obtaining module configured to obtain a picture browsing layer corresponding to the target picture;
wherein the load display module is further configured to load the picture browsing layer obtained by the obtaining module in the picture gallery interface and display the target picture corresponding to the picture browsing layer in the picture gallery interface.

8. (canceled)

9. The browser of claim 7, wherein the browser further comprises:
a second generation unit configured to generate a reminder prompt message of switching pictures of picture galleries;
a first output unit configured to output the reminder prompt message of switching pictures of picture galleries generated by the second generation unit.

10. The browser of claim 7, wherein the browser further comprises:
a third generation unit configured to generate an interactive prompt message of whether performing switching pictures of picture galleries;
a second output unit configured to output the interactive prompt message of whether performing switching pictures generated by the third generation unit on the picture gallery interface; wherein the interactive prompt message is configured to confirm whether performing switching pictures of picture galleries;
the first generation unit is further configured to, after receiving a confirmation of performing switching pictures of picture galleries corresponding to the interactive prompt message output by the second output unit, generate a picture gallery-picture gradual change switch mode.

11. A non-transitory computer-readable storage medium comprising a set of instructions for performing a method for switching pictures of picture galleries, the set of instructions to direct at least one processor to perform acts of:
receiving a picture switching instruction and judging whether an original picture gallery corresponding to an original picture displayed on a picture gallery interface and a target picture gallery corresponding to a target picture are a same gallery, wherein the target picture is a picture to be switched corresponding to the original picture;
if the original picture gallery and the target picture gallery are same, directly switching the original picture to the target picture;
if the original picture gallery and the target picture gallery are different, indirectly switching the original picture to the target picture;
wherein the indirectly switching the original picture to the target picture comprises:
configuring a background of a transparent mask corresponding to the picture gallery interface according to a target background carried in a background configuration instruction of the transparent mark corresponding to the picture gallery interface;
loading the transparent mark in the picture gallery interface, and displaying the target background of the transparent mark in the picture gallery interface;
after obtaining a picture browsing layer corresponding to the target picture, loading the picture browsing layer in the picture gallery interface and displaying the target picture corresponding to the picture browsing layer in the picture gallery interface.

12. (canceled)

13. (canceled)
